(19) United States
(12) Patent Application Publication
(10) Pub. No.: US 2024/0296335 A1
(43) Pub. Date: Sep. 5, 2024

(54) KNOWLEDGE DISTILLATION USING CONTEXTUAL SEMANTIC NOISE

(71) Applicant: ADOBE INC., SAN JOSE, CA (US)

(72) Inventors: Surgan Jandial, Noida (IN); Shripad Vilasrao Deshmukh, New Delhi (IN); Balaji Krishnamurthy, Noida (IN)

(21) Appl. No.: 18/112,911

(22) Filed: Feb. 22, 2023

(51) Int. Cl. G06N 3/096; G06N 3/045

(52) U.S. Cl. CPC G06N 3/096; G06N 3/045

(57) ABSTRACT

In various examples, a student model is trained based on a teacher model and a past student model. For example, a first set of labels are generated by a teacher model based on training data, a subset of labels are replace with labels generated by a past student model based on the training data, and a student model it trained based on these labels and the training data.

### BACKGROUND

Various types of artificial intelligence (AI) models can be trained using various training techniques. For example, deep neural networks (DNNs) can be trained using regularization or other deep learning techniques. One example of regularization includes label regularization which can be used to augment or modify training labels used to train DNNs. In addition, knowledge distillation (KD) is a training technique that uses a pre-trained model (e.g., a “teacher”) to generate labels used to train a new model (e.g., a “student”).

### SUMMARY

Embodiments described herein are directed to systems and methods for training artificial intelligence (AI) models, such as neural networks (NN), using knowledge distillation that includes contextual semantic noise. Advantageously, in various embodiments, the systems and methods described are directed towards label regularization techniques used during knowledge distillation that add contextual semantic noise to labels (e.g., soft labels) used during training the student network. In particular, during training, a percentage of the labels generated by the teacher network for training are replaced with labels generated by a previous student network (e.g., prior state of the student network). For example, training occurs over a certain number of epochs (e.g., iterations) during which output logits of the student network are compared to labels generated by the teacher network using a loss function (e.g., the cross-entropy loss function). In the example above, at a given iteration, for each element of a training dataset there is a threshold probability that a label generated by a previous version of the student network (e.g., the student network from a prior iteration) is used for training. As such, these labels contain contextual semantic noise that can generate a trained model (e.g., the student model after training is completed) that generates improved results over a model trained using random noise or other regularization techniques.

In some examples, in early iterations, the labels generated by the student network do not contain sufficient contextual semantic information and, as a result, could result in suboptimal results. Therefore, in such examples, a warmup interval (e.g., a certain number of training iterations) is included to allow the student network to be trained and allow for the labels generated to develop and/or include sufficient contextual semantic information to improve results. During the warmup interval, for example, the labels from the teacher network are exclusively used for training and, once the warmup interval has expired, labels from the prior student network (e.g., the state of the student network at the expiration of the warmup interval) can be used for training based on the probability threshold. In addition to the warmup interval, the prior student network can be periodically or aperiodcally updated at the expiration of an update interval. For example, at the expiration of a certain number of training iterations (e.g., 20 epochs), the state of the student network is updated. In this manner, as the contextual semantic information included in the labels generated by the student improves, the state of the prior student network can be updated to capture such contextual semantic information.

The systems and methods described are capable of training smaller models based on larger models using contextual semantic noise to avoid overfitting, where the smaller models generate the same or similar results as the larger models. In addition, other systems simply add random noise to the training label to avoid overfitting and, as a result, generate trained models that can perform poorly in certain situations. Furthermore, in various embodiments, the systems and methods, by using previous states of the student network, obtain labels that are sufficiently noisy, as the student network has not converged, and include more semantic and/or contextual information that can improve the resulting model. Lastly, the training techniques can include a warmup interval to allow the student network to develop semantic and/or contextual information and the previous state of the student network can be updated to further develop semantic and/or contextual information.

### BRIEF DESCRIPTION OF THE DRAWINGS

The present invention is described in detail below with reference to the attached drawing figures, wherein:

FIG. 1 depicts an environment in which one or more embodiments of the present disclosure can be practiced.

FIG. 2 depicts an environment in which a student model can be trained using contextual semantic noise, in accordance with at least one embodiment.

FIG. 3 depicts an example process flow for training a student model using contextual semantic noise, in accordance with at least one embodiment.

FIG. 4 depicts an example process flow for updating a version of a past student model, in accordance with at least one embodiment.

FIG. 5 depicts an example process flow for performing a task using a student model trained using contextual semantic noise, in accordance with at least one embodiment.

FIG. 6 is a block diagram of an exemplary computing environment suitable for use in implementations of the present disclosure.

### DETAILED DESCRIPTION

Embodiments described herein generally relate to training techniques that add contextual semantic noise to training labels used to train a student model. In accordance with some aspects, the systems and methods described are directed to replacing a percentage of labels generated by a teacher model with labels generated by a past version of the student model. These labels generated by the past version of the student model, in various embodiments, contain contextual and/or semantic information and thereby can prevent overfitting when training a smaller student model using a larger pre-trained teacher model. In one example, the student model is trained for a number of iterations (e.g., epochs), during each iteration the teacher model generates labels based on training data and a percentage of the labels (e.g., based on a probability threshold) are replaced with labels generated by the past version of the student model. In such an example, these labels are then used to update the parameters of the student network using a loss function (e.g., cross-entropy loss).

In particular, knowledge distillation is a training technique for models that can compress, miniaturize, and/or transfer parameters of a “teacher” model (e.g., deeper and/or wider models). For example, knowledge distillation can be used to generate a “student” model that produces the same or similar results as the “teacher” model (e.g., a larger model with a greater number of layers) that would otherwise require a greater amount of computational resources and time to produce the results. In general, knowledge distillation includes training a NN (e.g., the “student” network) based on outputs (e.g., soft labels) generated by a trained NN (e.g., the “teacher” network).

However, training techniques such as knowledge distillation can result in overfitting. For example, overfitting can occur when the student network generates labels that too closely match labels generated by the teacher network and therefore fail to generate accurate labels for unseen data (e.g., data not included in the training set). Regularization can be used to prevent overfitting, for example, by adding noise (e.g., random Gaussian noise) to the labels generated by the teacher network. Adding random noise while regularizing labels can prevent overfitting but can still generate models that produce suboptimal results.

Furthermore, in various embodiments, a warmup interval is used to allow the student model to develop the contextual and/or semantic information. In one example, the warmup interval includes a number of iterations during which the labels generated by the teacher model are not replaced with labels generated by a past version of the student model. In some embodiments, the past version of the student model is updated at the expiration of an update interval. For example, after a number of iterations, the past version of the student model is updated with the current version of the student model.

In various embodiments, training the student model includes matching output logits of the student models with “truth” labels (e.g., training labels) using a loss function such as the cross-entropy loss function. Furthermore, as described in detail below, the training techniques described herein, in various embodiments, are used to train a smaller student model (e.g., fewer layers, less parameters, etc.) with the outputs (e.g., labels) of a larger pre-trained teacher network. For example, given an input image, the output logits of the student network and the teacher network are included as inputs to a loss function to train the student model (e.g., modify the parameters of the student model using backpropagation).

Other solutions train or otherwise lead to models that are overfit. In one example, the resulting student model produces results that too closely match the teacher model and do not perform well on unseen and/or new data. Furthermore, certain solutions attempt to avoid overfitting by adding random noise to labels generated by the teacher model. For example, random Gaussian noise can be added to the logits used for training the student model. However, the random Gaussian noise does not include contextual or semantic information and therefore can produce models that generate suboptimal results. The systems and methods described in the present disclosure address at least some of these issues by the addition of contextual and/or semantic information obtained from labels generated by the past version of the student model.

Aspects of the technology described herein provide a number of improvements over existing technologies. For instance, the technology described herein adds noise to labels used for training as a result of the past version of the student model not reaching convergence. In addition, in various embodiments, labels generated by the past version of the student model contain contextual and/or semantic information (e.g., beyond simply random noise) and therefore provide improved results when used during training.

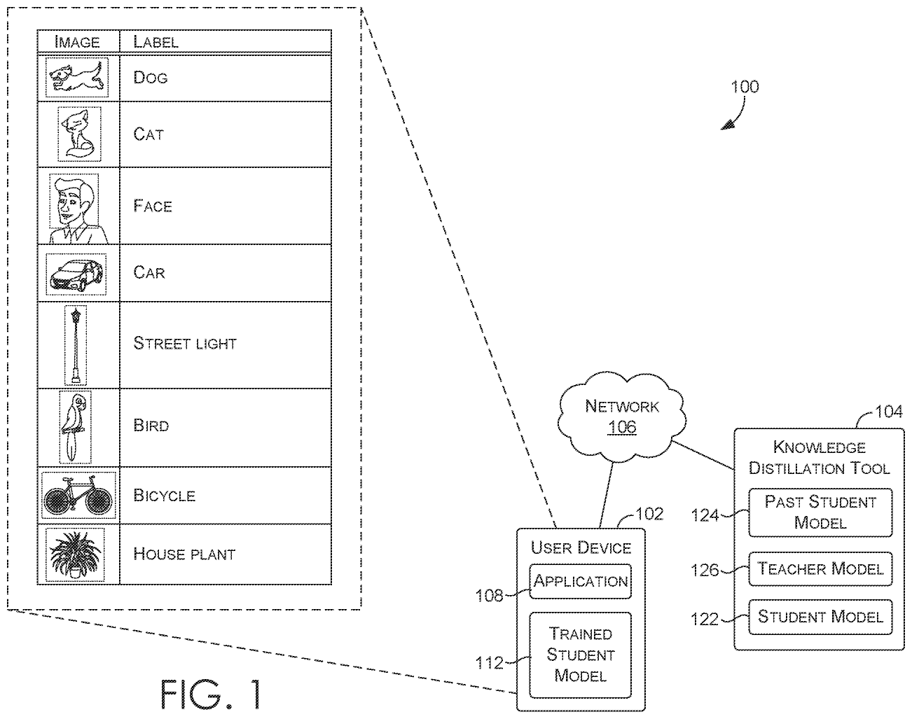

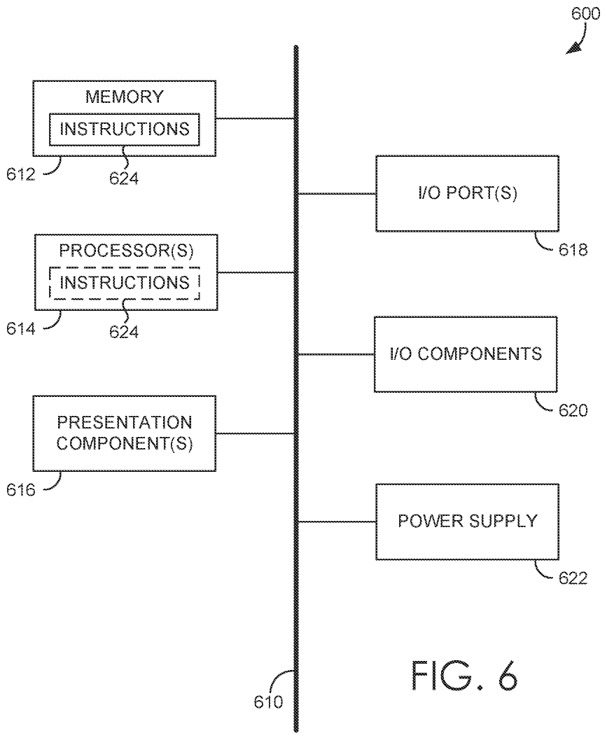

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 6.

It should be understood that operating environment 100 shown in FIG. 1 is an example of one suitable operating environment. Among other components not shown, operating environment 100 includes a user device 102, a knowledge distillation tool 104, and a network 106. Each of the components shown in FIG. 1 can be implemented via any type of computing device, such as one or more computing devices 600 described in connection with FIG. 6, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the knowledge distillation tool 104 includes multiple server computer systems cooperating in a distributed environment to perform the operations described in the present disclosure.

User device 102 can be any type of computing device capable of being operated by an entity (e.g., individual or organization) and obtains data from knowledge distillation tool 104 and/or a data store which can be facilitated by knowledge distillation tool 104 (e.g., a server operating as a frontend for the data store). The user device 102, in various embodiments, has access to or otherwise maintains a trained student model 112 which performs various tasks (e.g., classification tasks, prediction tasks, clustering tasks, associated tasks, and/or other tasks that are performable by an AI model) accessible through an application 108. For example, the application 108 provides the entity with access to the trained student model 112 to perform one or more tasks.

In some implementations, user device 102 is the type of computing device described in connection with FIG. 6. By way of example and not limitation, the user device 102 can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the knowledge distillation tool 104. For example, the application 108 obtains the trained student model 112 from the knowledge distillation tool 104 to perform classification tasks. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and the knowledge distillation tool 104. In some cases, the application 108 is integrated into the operating system (e.g., as a service). It is therefore contemplated herein that “application” be interpreted broadly. Some example applications include ADOBE® SIGN, a cloud-based e-signature service, and ADOBE ACROBAT®, which allows users to view, create, manipulate, print, and manage documents.

For cloud-based implementations, for example, the application 108 is utilized to interface with the functionality implemented by the knowledge distillation tool 104. In some embodiments, the components, or portions thereof, of the knowledge distillation tool 104 are implemented on the user device 102 or other systems or devices. Thus, it should be appreciated that knowledge distillation tool 104, in some embodiments, is provided via multiple devices arranged in a distributed environment that collectively provide the functionality described herein. Additionally, other components not shown can also be included within the distributed environment.

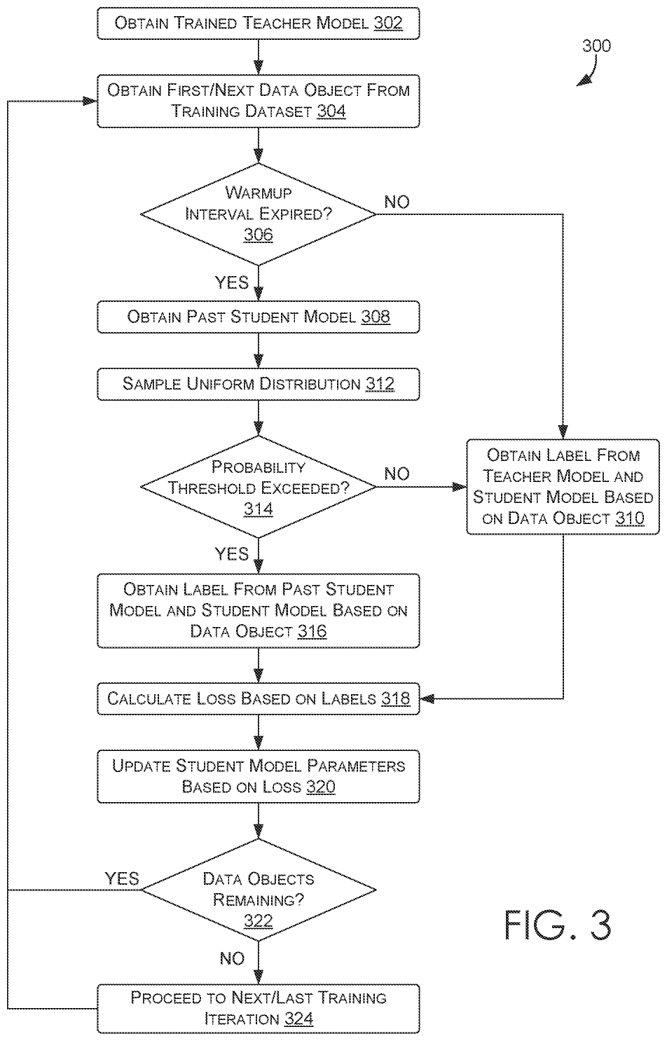

As illustrated in FIG. 1, the knowledge distillation tool 104 includes a student model 122, a past student model 124, and a teacher model 126. In various embodiments, the student model 122, the past student model 124, and/or the teacher model 126 can include various AI models such as neural network. In one example, the student model 122 is a convolutional neural network (CNN) with fewer layers than the teacher model 126 CNN. In various embodiments, the knowledge distillation tool 104 trains the student model 122 using outputs of the teacher model 126 (e.g., labels generated by the teacher model 126 converted to soft labels for training). Furthermore, in some embodiments, the knowledge distillation tool 104 performs regularization of the training labels (e.g., labels generated by the teacher model 126) based on contextual semantic information (e.g., labels) generated by the past student model 124. As described in detail below, the past student model 124 includes a version of the student model 122 stored from a prior iteration of the training method described in connection with FIG. 3.

In an embodiment, training the student model 122 includes matching the output logits of student model 122 with truth labels, using the cross-entropy loss function as illustrated by the following equation (1):

$${ℒ}_{CE} = H ( softmax ( z ) , \hat{y} ) . \qquad ( 1 )$$

In equation (1), z represents the output (e.g., logits) of the student model 122 and ŷ represents the output of the teacher model 126 (e.g., truth labels for training purposes). For example, the knowledge distillation tool 104 is used to train the smaller student model 122 with the output of the larger pre-trained teacher model 126 along with truth labels. For example, given an input image x, the output logits from student model 122 and teacher model 126 can be written as zₛ=fₛ(x) and zₜ=fₜ(x) respectively, where fₛ represents the student model 122, fₜ represents the teacher model 126, zₛ represents the output of the student model 122, and zₜ represents the output of the teacher model 122. In some embodiments, these logits (e.g., zₛ and zₜ) are further softened via a temperature parameter (T) and passed through a softmax function to obtain outputs yₛ, and yₜ respectively represented by equation (2):

$${y}_{s} = softmax ( {z}_{s} / τ ) , {y}_{t} = softmax ( {z}_{t} / τ ) . \qquad ( 2 )$$

In some embodiments, the knowledge distillation tool 104 includes a knowledge distillation loss term to equation (1) above for matching logits generated by the student model 122 and teacher model 126:

$${ℒ}_{K D} = {τ}^{2} K L ( {y}_{s} , {y}_{t} ) \qquad ( 3 )$$

where KL refers to the Kullback-Leibler Divergence and τ is the temperature parameter. In such embodiments, the combination of equations (1) and (3) represents a training objective which can be written as:

$$ℒ = {αℒ}_{K D} + ( 1 - α ) {ℒ}_{C E} \qquad ( 4 )$$

where α is a weight balancing parameter for combining the training objectives (e.g., equation (1) and (3)).

In various embodiments, the knowledge distillation tool 104, during an iteration, samples training data and data objects sampled from the training data are processed by the teacher model 126 and the student model 122, the output (e.g., logits, labels, etc.) of the teacher model 126 and the student model 122 are then used to train the student model 122. For example, a set of input images from a training dataset are processed by the teacher model 126 and the student model 122 and the resulting outputs are compared using a loss function (e.g., equation (4) above) in order to update the parameters of the student model 122. In an embodiment, the outputs at a particular iteration T are taken as zₛ^{T}∈R^{C} and zₜ∈R^{C}, where zₜ is the output of the teacher model 126, zₛ^{T} is the output of the student model 122 at iteration T, and R is the set of real numbers and C is the number of classes):

$${z}_{s}^{T} = {f}_{s} ( x ; {θ}_{s}^{T} ) , {z}_{t} = {f}_{t} ( x ; {θ}_{t} ) \qquad ( 5 )$$

where fₜ(•;θₜ) represents the teacher model 126, fₛ(•;θₛ^{T}) represents the student model 122 at iteration T, and x represents the input (e.g., training data).

In various embodiments, during training by the knowledge distillation tool 104, in order to regularize training of the student model 122 with soft labels zₜ generated by the teacher model 126 and incorporate contextual and/or semantic noise, the past student model 124 is obtained and used to generate an output zₛ^{T}^{ₚₐₛₜ} as:

$${z}_{s}^{{T}_{p a s t}} = {f}_{s} ( x ; {θ}_{s}^{{T}_{p a s t}} ) \qquad ( 6 )$$

where the past student model 124 is from an iteration Tₚₐₛₜ<T and fₛ(•;θₛ^{T}^{ₚₐₛₜ}) represents the past student model 124. For example, after a warmup interval of twenty iterations, the student model 122 is saved as the past student model 124 and the knowledge distillation tool continues to iteration twenty-one. In various embodiments, in a particular training iteration, an output of the past student model 124 is used to replace an output of the teacher model 126 in order to add contextual semantic noise to the training labels. For example, a percentage of total number of training batches (e.g., training labels, images, training data, logits, etc.) taken over all the iteration are replaced.

In an embodiment, the knowledge distillation tool 104 samples a number β randomly from Uniform Distribution [symbol] (0, 1) and then, based on the threshold probability pₜₕ, determines to use the output of the past student model 124 to replace an output z_{t,reg} given by the following equation:

$${z}_{t , reg} = \{ \begin{matrix}{z}_{s}^{{T}_{past}} & β , {p}_{th} , β ∼ 𝒰 ( 0 , 1 ) \\ {z}_{t} & otherwise\end{matrix} . \qquad ( 7 )$$

However, in some embodiments, during early iteration, the past student model 124 could generate outputs that malign the student models 122 target (e.g., training objectives). Therefore, in some embodiments, a warmup interval T_{warmup} is used prior to regularization. For example, teacher model 126 supervision (aₜ) for interval T can be represented by the following equation:

$${a}_{t} = \{ \begin{matrix}{z}_{t} & T < {T}_{warmup} \\ {z}_{t , reg} & otherwise\end{matrix} . \qquad ( 8 )$$

In various embodiments, the past student model 124 is updated (e.g., the current state of the student model 122 is resampled) at the expiration of an update interval f_{update}. For example, after the warmup interval has expired, the knowledge distillation tool 104 updates the past student model 124 after the twenty iterations. In various embodiments, the past student model 124 is replaced with the current state (e.g., at the current iteration T) of the student model 122. In other embodiments, the parameters of the past student model 124 are updated with the current parameters (e.g., at the current iteration T) of the student model 122.

In various embodiments, given equation (4), the training objective L for the student model 122 is given by the following equation:

$$ℒ = {αℒ}_{K D} ( {z}_{s}^{T} / τ , {a}_{t} / τ ) + ( 1 - α ) {ℒ}_{CE} ( {z}_{s}^{T} , \hat{y} ) \qquad ( 9 )$$

where ŷ is the one-hot ground truth label and a is the loss balancing parameter between the two loss terms. In various embodiments, given the past student model 124 logits zₛ^{T}^{ₚₐₛₜ}(x) and the teacher model 126 logits zₜ(x), the knowledge distillation tool 104 samples a number β randomly from Uniform Distribution [symbol] (0, 1) and then, based on the threshold probability pₜₕ, the student-regularized teacher outputs (e.g., the training outputs) z_{t,reg} are described by the following algorithm:

```
Input: Current State Student Model Parameters θₛ^{t}, Teacher Model
Parameters θₜ, Update frequency f_{update}, number of warm-up iterations
T_{warmup}, learning rate η, loss scaling parameter λ, number of training
iterations N.
θₛ^{T}^{ₚₐₛₜ} = NULL
for step T = 1 to N do
    Sample (x, y)ᵢ₌₁^{B}, from train data
    z_{s,i}^{T} = fₛ(xᵢ;θₛ^{T})
    z_{t,i} = fₜ(xᵢ;θₛ^{T})
    z_{t,reg,i} = z_{t,i}
    if step > T_{warmpup} then
    z_{s,i}^{T}^{ₚₐₛₜ} = fₛ(xᵢ;θₛ^{T}^{ₚₐₛₜ})
    β ~ U(0,1)
    if β < pₜₕ then
  z_{t,reg,i} = zₛ^{T}^{ₚₐₛₜ} [symbol]  Pick from past students label
    end if
    end if
    $ℒ = {αℒ}_{K D} ( \frac{{z}_{s , i}^{T}}{τ} , \frac{{z}_{t , reg , i}}{τ} ) + ( 1 - α ) {ℒ}_{C E} ( {z}_{s , i}^{T} , {\hat{y}}_{i} )$
    θₛ^{T+1} ← θₛ^{T} − η ▾ L_{θ}_{ₛ}_{^{T}} (xᵢ, yᵢ; θₛ^{T})
    if T % f_{update} = = 0 then
    θₛ^{T}_{ₚₐₛₜ} ← θₛ^{T}
    end if
end for
```

In various embodiments, once training is complete (e.g., the number of training iterations are completed), the trained student model 112 (e.g., the student model 122 after training) is provided to the user device 102 to perform various tasks via the application 108. For example, the trained student model 112 performs the object detection task and displays the results in a user interface of the application 108.

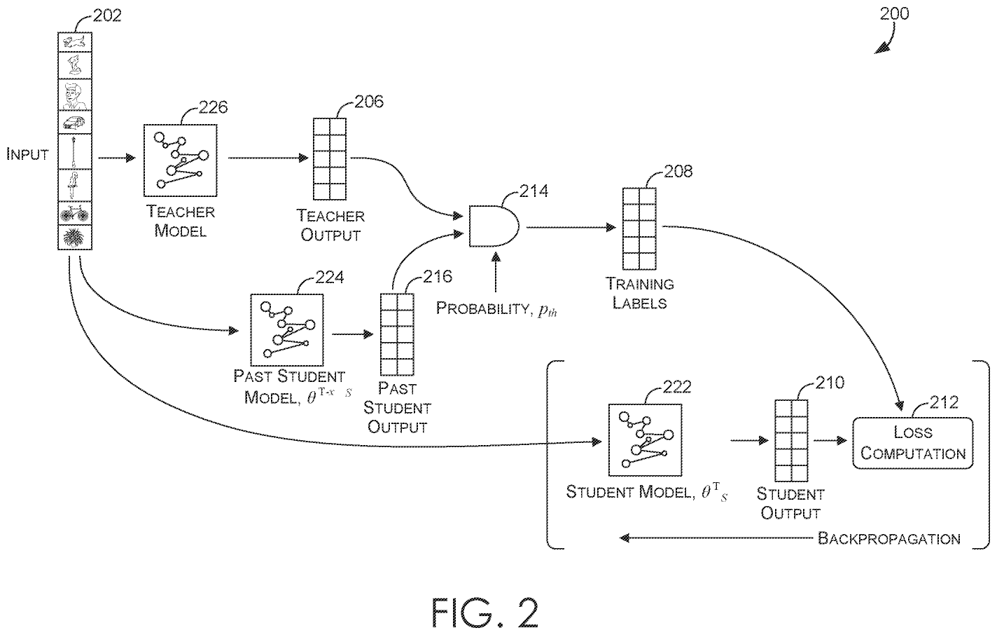

FIG. 2 is an environment 200 in which a student model 222 can be trained using contextual semantic noise, in accordance with at least one embodiment. In various embodiments, a knowledge distillation tool or similar computing device (e.g., server computer system executing source code to perform the operations described below) trains the student model 222 using the knowledge distillation techniques illustrated in environment 200. For example, an input 202 is provided to a teacher model 226, a past student model 224, and the student model 222. In an embodiment, the input 202 includes training data such as image, text, annotated data, or other data objects that can be used to train a machine learning model. In one example, the input 202 includes a set of annotated images used to train the teacher model 226. In some embodiments, the input 202 is a subset and/or batch of data objects obtained from a training dataset or other collection of data objects.

In an embodiment, the teacher model 226, the past student model 224, and the student model 222 generate outputs based on the input 202 (e.g., a teacher output 206, a past student output 216, and the student output 210 respectively). In other embodiments, the outputs (e.g., the teacher output 206, the past student output 216, and/or the student output 210) are generated as needed. For example, the probability 214 (e.g., pₜₕ) is used to determine whether training labels 208 are replaced with labels from the past student output 216. In some embodiments, the past student output 216 is generated once the probability 214 indicates the particular training label is to be replaced.

As described above, in various embodiments, a percentage of the labels from the teacher output 206 are replaced with labels generated by the past student model 224 (e.g., replaces with the past student output 216). For example, a number is sampled from the Uniform Distribution, and if the number satisfies a threshold (e.g., pₜₕ), a particular label from the teacher output 206 is replaced with a corresponding label (e.g., the label generated based on the same image from the input 202) from the past student output 216 in order to generate the training labels 208. In various embodiments, the past student output 216 includes contextual and/or semantic information associated with the input 202. Furthermore, in some embodiments, the past student model 224 is generated after a warmup interval. For example, the student model 222 is trained using the teacher output 206 (e.g., the training labels 208 include only the teacher output 206) for a first number of training iterations (e.g., twenty iterations) until the student model 222 is trained enough such that the labels generated contain contextual and/or semantic information.

In various embodiments, the training labels 208 are used to train the student model 222 by at least using a loss computation 212 between the student output 210 and the training labels 208. For example, the loss computation includes the training objectives described above in connection with FIG. 1. Furthermore, in various embodiments, the loss computation is used to update the parameters of the student model 222 using backpropagation.

The training techniques illustrated in environment 200, in various embodiments, are performed for a number of training iterations. Furthermore, in some embodiments, the past student model 224 is updated at the expiration of an update interval. For example, after ten training iterations the past student model 224 can be updated based on the student model 222 (e.g., the parameters of the student model 222 at the current iteration).

FIG. 3 is a flow diagram showing a method 300 for training a student model using labels containing contextual semantic information in accordance with at least one embodiment. The method 300 can be performed, for instance, by the knowledge distillation tool 104 of FIG. 1. Each block of the method 300 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, the system implementing the method 300 obtains a trained teacher model. As described above in connection with FIG. 1, in various embodiments, the trained teacher model includes a machine learning model trained using a training dataset to perform one or more tasks (classification, object identification, etc.). For example, the trained teacher model includes a CNN trained to label objects within images. Furthermore, as described above, the trained teacher model can be a larger model than the student model training using the method 300.

At block 304, the system implementing the method 300 obtains the first/next data object from a training dataset. In an embodiment, the system implementing the method 300 obtains a set of data objects (e.g., inputs) from the training dataset. For example, the system implementing the method 300 obtains a set of images from a training dataset used to train the teacher model. In various embodiments, the student model is trained over a number of training iterations and, during the training iterations, the training dataset is sampled to obtain additional images to train the student model.

At block 306, the system implementing the method 300 determines whether the warmup interval has expired. In various embodiments, a warmup interval (e.g., a number of training iterations less than the total number of training iterations) is used to allow the method 300 to generate a student model that is capable of generating labels with sufficient contextual and/or semantic information to be used in training the student model. In other embodiments, the warmup interval is excluded from the method 300. If the warmup interval has expired, the system implementing the method 300 continues to block 308. However, if the warmup interval has not expired, the system implementing the method 300 continues to block 310.

At block 308, the system implementing the method 300 obtains the past student model. In one example, the past student model is generated based on the student model at the current iteration when the warmup interval expires. In various embodiments, the past student model is maintained by the system implementing the method 300 and used to generate labels for data objects included in the training dataset. At block 312, the system implementing the method 300 samples the uniform distribution. In other embodiments, the system implementing the method 300 obtains a random number or pseudorandom number and determines if the probability threshold has been exceeded based on the number.

At block 314, the system implementing the method 300 determines whether the value sampled from the uniform distribution exceeds the probability threshold. For example, the probability threshold indicates a percentage of the training labels generated by the trained teacher model to be replaced with labels generated by the past student model. If the probability threshold is not exceeded, the system implementing the method 300 continues to block 310. However, if the probability threshold is exceeded, the system implementing the method 300 continues to block 316.

At block 310, the system implementing the method 300 obtains labels from the teacher model and the student model based on the data object. For example, the teacher model generates a label based on the input image to be used in the training labels and the student model generates a label based on the input image to be used to in the loss calculation in order to update the parameters of the student model. At block 316, the system implementing the method 300 obtains labels from the past student model and the student model based on the data object. For example, the past student model generates a label based on the input image to be used in the training labels and the student model generates a label based on the input image to be used to be used in the loss calculation in order to update the parameters of the student model.

At block 318, the system implementing the method 300 calculates the loss based on the label. For example, the cross-entropy loss function is used to calculate the loss between the training labels (e.g., labels generated by the teacher model and/or past student model) and the student model. At block 320, the system implementing the method 300 updates the student model parameters based on the loss function. In one example, backpropagation is used to update the parameters of the student model based on the loss function.

At block 322, the system implementing the method 300 determines if there are data objects remaining in the set of data objects sampled from the training dataset. For example, if there are no data objects remaining, the system implementing the method 300 continues to block 324. However, in another example, if there are data objects remaining, the system implementing the method 300 returns to block 304 and continues to the next data object. Furthermore, in various embodiments, once all of the data objects from the set of data objects sampled from the training data set have been processed by the system implementing the method 300, the method 300 continues at block 324 and proceeds to the next/last training iteration. For example, if the total number of training iterations is one-hundred, the method 300 is performed for that number of iterations.

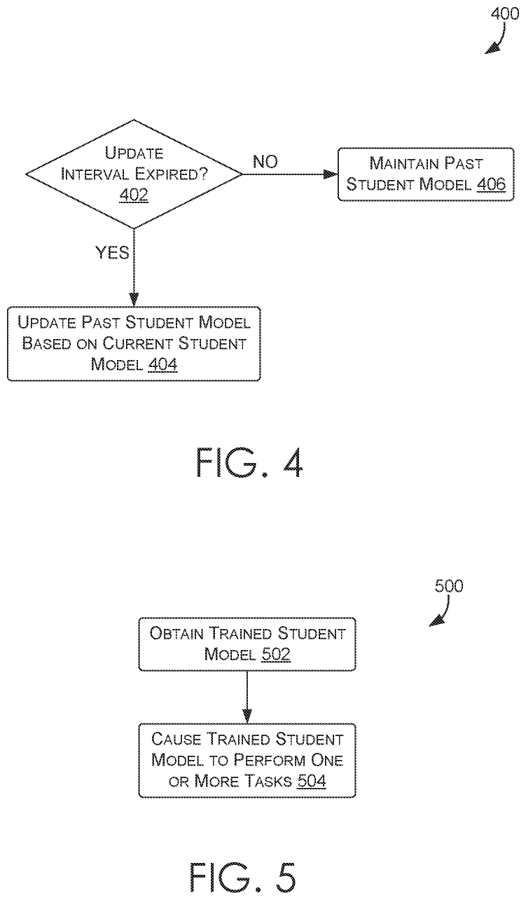

FIG. 4 is a flow diagram showing a method 400 for updating a past student model in accordance with an embodiment. The method 400 can be performed, for instance, by the knowledge distillation tool 104 of FIG. 1. As shown at block 402, the system implementing the method 400 determines if an update interval has expired. As described above, in various embodiments, the training techniques can be performed over a number of iterations. For example, as part of the method 300 described above in connection with FIG. 3, at the end of an iteration, the system implementing the method 400 determines if the update interval (e.g., thirty training iterations) has expired.

In an embodiment, if the system implementing the method 400 determines the update interval has expired, the method 400 continues to block 404. At block 404, the system implementing the method 400 updates the past student model based on the current student model. For example, the parameters of the student model are used to update the parameters of the past student model. In an embodiment, if the system implementing the method 400 determines the update interval has not expired, the method 400 continues to block 406. At block 406, the system implementing the method 400 maintains the past student model.

FIG. 5 is a flow diagram showing a method 500 for causing a trained student model to perform one or more tasks in accordance with an embodiment. The method 500 can be performed, for instance, by the user device 102 of FIG. 1. As shown at block 502, the system implementing the method 500 obtains a trained student model. For example, the student model trained using method 300 can be obtained by an application executed by the user device. At block 504, the system implementing the method 500 causes the trained student model to perform one or more tasks. For example, as described above in connection with FIG. 1, the trained student model generates labels for images through the application executed by the user device.

Having described embodiments of the present invention, FIG. 6 provides an example of a computing device in which embodiments of the present invention may be employed. Computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 6 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. As depicted, memory 612 includes instructions 624. Instructions 624, when executed by processor(s) 614 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 600. Computing device 600 may be equipped with depth cameras, such as stereoscopic camera systems, infrared camera systems, RGB camera systems, and combinations of these, for gesture detection and recognition. Additionally, computing device 600 may be equipped with accelerometers or gyroscopes that enable detection of motion. The output of the accelerometers or gyroscopes may be provided to the display of computing device 600 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
obtaining a teacher model trained using a training dataset;
obtaining a subset of training data from the training dataset to train a student model; and
training the student model by at least:
obtaining a first set of labels generated by the teacher model based on the subset of training data;
providing a modified set of labels by replacing a first label of the first set of labels with a second label generated by a past student model based on a value exceeding a probability threshold;
causing the student model to generate a second set of labels based on the subset of training data; and
modifying at least one parameter of the student model based at least in part on a result of a loss function applied to the modified set of labels and the second set of labels.

2. The method of claim 1, wherein training the student model is performed for a number of training iterations.

3. The method of claim 1, wherein replacing the first label of the first set of labels with the second label is performed at an expiration of a warmup interval.

4. The method of claim 1, wherein the method further comprises updating the past student model based on the student model at an expiration of an update interval.

5. The method of claim 1, wherein the student model is a neural network.

6. The method of claim 1, wherein the value is sampled from a uniform distribution.

7. The method of claim 1, wherein the loss function is a cross entropy loss function.

8. A non-transitory computer-readable medium storing executable instructions embodied thereon, which, when executed by a processing device, cause the processing device to perform operations comprising:
training a student model using a teacher model and a set of training data by at least:
causing the teacher model to generate a first set of labels based on a subset of training data of the set of training data;
providing a modified set of labels by replacing at least one label of the first set of labels with labels generated by a previous version of the student model based on a probability threshold;
causing the student model to generate a second set of labels based on the subset of training data; and
updating at least one parameter of the student model based on a loss function taking as inputs the modified set of labels and the second set of labels.

9. The medium of claim 8, wherein training the student model is performed over a first number of iterations.

10. The medium of claim 9, wherein replacing the at least one label of the first set of labels with the labels generated by the previous version of the student model is performed after a second number of iterations are completed.

11. The medium of claim 9, wherein the executable instructions embodied further included executable instructions which, when executed by the processing device, causes the processing device to perform the operations comprising updating the previous version of the student model with a current version of the student model based on a determination that a second number of iterations have completed.

12. The medium of claim 8, wherein the student model is smaller than the teacher model.

13. The medium of claim 8, wherein the probability threshold indicates a probability of replacing a label of the first set of labels with the labels generated by the previous version of the student model.

14. The medium of claim 8, wherein the student model and the teacher model are neural networks.

15. The medium of claim 8, wherein the teacher model is trained based on the set of training data and a set of ground truth labels associated with the set of training data.

16. A system comprising:
a memory component; and
a processing device coupled to the memory component, the processing device to perform operations comprising:
obtaining a first set of labels generated by a teacher model based on training data;
generating a second set of labels by at least replacing a label of the first set of labels with labels generated by a past student model based on the training data; and
training a student model based on the second set of labels.

17. The system of claim 16, wherein the past student model is updated based on a current version of the student model at an expiration of an update interval.

18. The system of claim 16, wherein the past student model is generated at an expiration of a warmup interval.

19. The system of claim 16, wherein the processing device is further configured to perform the operations comprising performing a training iteration by at least:
obtaining a third set of labels generated by the teacher model;
generating a fourth set of labels by at least replacing labels of the third set of labels with labels generated by the past student model; and
training the student model based on the fourth set of labels.

20. The system of claim 16, wherein the labels generated by the past student model contain contextual semantic information.
